(19) United States
(12) Patent Application Publication
(10) Pub. No.: US 2011/0220764 A1
(43) Pub. Date: Sep. 15, 2011

(54) MECHANICALLY OPENING EMERGENCY PARACHUTE

(76) Inventor: BONG H. SUH, Rockville, MD (US)

(21) Appl. No.: 13/035,593

(22) Filed: Feb. 25, 2011

Related U.S. Application Data
(60) Provisional application No. 61/282,640, filed on Mar. 10, 2010.

(51) Int. Cl. B64D 17/02; B64D 17/24; B64D 17/40; B64D 17/30

(52) U.S. Cl. 244/145

(57) ABSTRACT

The mechanically opening emergency parachute is a parachute that may be opened quickly at low altitudes, such as during an emergency exit from an office building. The parachute includes a tube having opposed upper and lower ends, with an upper end of a suspension cord being secured to the lower end thereof. An upper annular runner is resiliently mounted on the tube. First ends of a plurality of ribs are pivotally attached to the upper end of the tube. An upper stretcher is mounted on the upper annular runner and includes a plurality of supports, with each support extending therefrom to one of the ribs. A lower stretcher is secured to the lower end of the suspension cord and includes a plurality of risers radially extending therefrom. A canopy is secured to the ribs, and a plurality of suspension lines extend between the risers and the canopy.

### CROSS-REFERENCE TO RELATED APPLICATION

This application claims the benefit of U.S. Provisional Patent Application Ser. No. 61/282,640, filed Mar. 10, 2010.

### BACKGROUND OF THE INVENTION

1. Field of the Invention

The present invention relates to parachutes, and particularly to a mechanically opening emergency parachute that may be used quickly in emergency situations.

2. Description of the Related Art

A parachute is a device used to slow the motion of an object through an atmosphere by creating drag. A parachute is made from thin, lightweight fabric, support tapes and suspension lines. The lines are usually gathered through cloth loops or metal connector links at the ends of several strong straps called risers. The risers in turn are attached to the harness containing the load. As the thin material inflates it increases drag and in turn slowing down the object it is carrying. The parachute successfully slows down the object enough so that it does not break on impact with the ground.

Reserve parachutes usually have a ripcord deployment system, but most modern main parachutes used by sports parachutists use a form of hand-deployed pilot chute. A ripcord system pulls a closing pin (sometimes multiple pins), which releases a spring-loaded pilot chute, and opens the container; the pilot chute is then propelled into the air stream by its spring, then uses the force generated by passing air to extract a deployment bag containing the parachute canopy, to which it is attached via a bridle. A hand-deployed pilot chute, once thrown into the air stream, pulls a closing pin on the pilot chute bridle to open the container, and then the same force extracts the deployment bag.

Only the hand-deployed pilot chute may be collapsed automatically after deployment (by a kill line reducing the in-flight drag of the pilot chute on the main canopy). Reserves, on the other hand, do not retain their pilot chutes after deployment. The reserve deployment bag and pilot chute are not connected to the canopy in a reserve system. This is known as a free-bag configuration, and the components are often lost during a reserve deployment.

Occasionally, a pilot chute does not generate enough force either to pull the pin or to extract the bag. Causes may be that the pilot chute is caught in the turbulent wake of the jumper (the “burble”), the closing loop holding the pin is too tight, or the pilot chute is generating insufficient force. This effect is known as “pilot chute hesitation,” and, if it does not clear, it can lead to a total malfunction, requiring reserve deployment.

Paratroopers' main parachutes are usually deployed by static lines that release the parachute, yet retain the deployment bag that contains the parachute, without relying on a pilot chute for deployment. In this configuration, the deployment bag is known as a direct-bag system, in which the deployment is rapid, consistent, and reliable. This kind of deployment is also used by student skydivers going through a static line progression, a type of student program.

A parachute is carefully folded, or “packed” to ensure that it will open reliably. If a parachute is not packed properly it can result in death because the main parachute might fail to deploy correctly or fully. In the United States and many other developed countries, emergency and reserve parachutes are packed by “riggers”, who must be trained and certified according to legal standards. Sport skydivers are always trained to pack their own primary “main” parachutes.

Parachutes can malfunction in several ways. Malfunctions can range from minor problems that can be corrected in-flight and still be landed, to catastrophic malfunctions that require the main parachute to be cut away using a modern 3-ring release system, and the reserve to be deployed. Most skydivers also equip themselves with small barometric computers that will automatically activate the reserve parachute if the skydiver himself has not deployed a parachute to reduce his rate of descent by a preset altitude.

In the United States, the average parachute fatality rate is approximately one fatality in each 80,000 jumps. Most injuries and fatalities in sport skydiving occur under a fully functional main parachute because the skydiver made an error in judgment while flying the canopy, resulting in high-speed impact with the ground, impact with a hazard on the ground that might otherwise have been avoided, or collision with another skydiver under canopy. Types of malfunctions, include the “Mae West”, which is a type of round parachute malfunction which contorts the shape of the canopy into the appearance of a brassiere; “squidding”, which occurs when a parachute fails to inflate properly and its sides are forced inside the canopy; a “cigarette roll”, which occurs when a parachute deploys fully from the bag but fails to open, thus causing the parachute to appear as a vertical column of cloth (in the general shape of a cigarette), providing the jumper with very little drag; and an “inversion”, which occurs when one skirt of the canopy blows between the suspension lines on the opposite side of the parachute and then catches air. That portion then forms a secondary lobe with the canopy inverted. The secondary lobe grows until the canopy turns completely inside out.

Such malfunctions (and other accidents) are likely to occur when a parachute is deployed at too low an altitude, thus not allowing the parachute time to properly open and not providing sufficient drag to slow the user during the fall. Conventional parachutes cannot be used in emergency situations, such as when a user must evacuate an office building, because of this limitation.

FIG. 2 illustrates a typical folding umbrella. Umbrella 100 includes a telescopic tube 118 having opposed upper and lower ends, and having a center ball spring 108 or the like. A typical crook handle 102 is secured to the lower end thereof, with a tip cup 104 or the like being mounted on the upper end of handle 102 and annularly grasping the lower end of tube 118. An annular runner 110 is slidably mounted on telescoping tube 118. In an automatically opening umbrella, runner 110 is elastically biased, and is releasably held in a lowered or collapsed position by a lower spring-biased catch 106, and an upper spring-biased catch 112.

A stretcher, which includes a plurality of radially extending supports, is mounted on the upper end of runner 110 for extending ribs 116 (and the attached canopy 128) as runner 110 slides upwardly with respect to telescoping tube 118. Ribs 116 and canopy 128 extend from a notched end 120 of telescoping tube 118, which may also have cap 122 mounted above the canopy 128, adjacent the upper end 126, for securing the canopy 128 and ribs 116 in place. Additional decorative elements, such as ferule 124, are commonly added.

Referring to FIGS. 3-6, there is shown in greater detail a conventional automatically spreading and collapsing umbrella 200. As shown, umbrella 200 includes an elongate handle 210 with an upper end, a lower end and a middle portion therebetween, along with a ferrule 220, which is fixed on the upper end of the handle 210 for mounting a canopy 260. A tubular runner 230, which is sleeved, is slidably mounted on the middle portion of the handle 210, and a plurality of rib assemblies (for illustrative purposes, only one is shown in FIG. 3), which are disposed at an underside of the canopy 260 to support the canopy 260 in a spread-out position and in a collapsed position. A plurality of stretcher assemblies are further provided (with only one being shown for purposes of clarity) which interconnect the rib assemblies and the runner 230, so as to permit stretching and retracting of the rib assemblies in order to disposed the canopy 260 in a selected one of the spread-out position and the collapsed position when the runner 230 is moved along the handle 210.

Each rib assembly includes a main rib 241, a top rib 242 and an extending rib 243. Each stretcher assembly includes a stretcher 244 which is pivotally connected to the runner 230 and the main rib 241, and a connecting rod 245 which has one end pivotally connected to the stretcher 244 and the other end formed with a sliding slot 251 (best shown in FIG. 6) for sliding engagement with the top rib 242 by means of a pivot pin 221.

For automatically collapsing the rib assembly, a collapsing tension spring 250 and a resilient wire 246 are disposed between the rib assembly and the stretcher assembly. With reference to FIGS. 4 and 5, the resilient wire 246 is formed with a straight wire portion 261 at one end thereof. The straight wire portion 261 passes transversely through the main rib 241 for engagement with one end of the tension spring 250. The other ends of the resilient wire 246 and the tension spring 250 are respectively connected to an engaging hole 252 (as shown in FIG. 6) in the extending rib 243 and the connecting rod 245. As such, stretching of the rib assemblies will extend the tension spring 250 to store an elastic potential energy for restoring the tension spring 250 to facilitate collapsing of the rib assemblies. At the same time, the resilient wire 246 can actuate the extending rib 243 to retract inwardly toward the top rib 242.

FIG. 7 illustrates a mechanically opening parachute according to the applicant's co-pending PCT patent application serial no. PCT/US2009/005485, filed Oct. 6, 2009. This co-pending application is hereby incorporated by reference in its entirety. Referring to FIG. 7, the mechanically opening parachute 10 is shown being used in an emergency situation, such as when the user must exit an office building. Parachute 10 is similar in construction to a conventional automatically opening umbrella, such as the prior art umbrella 100 shown in FIG. 2, or the prior art umbrella 200 of FIGS. 3-6. As shown, the mechanically opening emergency parachute 10 includes a telescopic tube 18 having opposed upper and lower ends, and which is preferably spring-biased for automatic expansion thereof, as is shown in the prior art. Replacing the handle 102 of the conventional umbrella 100 is a harness 12, which is fastened about the waist or chest of the user. The harness may be in the form of a buckled belt, as shown, or may be any other suitable type of harness for securely holding the user to the parachute 10. It should be understood that telescopic tube 18 is shown for exemplary purposes only, and that it may include additional tubing, or may be provided so as to be collapsed in a multiple-part state.

The harness 12 is secured to the lower end of telescopic tube 18 by any suitable type of attachment. An annular runner 11 is slidably mounted on telescoping tube 18, as is conventionally known. Runner 11 is preferably elastically biased, and is releasably held in a lowered or collapsed position by a spring-biased catch 16, as in conventional, automatically opening umbrellas. Rather than a release button, catch 16 is released by the user pulling a handle 14, which is connected to the catch 16 by a cord 20. Release of spring-biased catch 16 causes the telescopic tube 18 to expand and causes runner 11 to move upwardly, with respect to telescopic tube 18, as is known in conventional, automatically opening umbrellas.

A stretcher 22, which includes a plurality of radially extending supports, as is well-known, is further provided, with ribs 24 (and the attached canopy 28) extending as runner 11 slides upwardly with respect to telescoping tube 18. Ribs 24 and canopy 28 extend from an upper end of telescoping tube 18, which may be a notched end 30, such as that shown in the conventional umbrella of FIG. 2. Preferably, an annular skirt 27 is formed about the lower edge of canopy 28, as shown, in order to maximize stability during usage. It should be understood that the overall contouring of canopy 28 or skirt 27 may be varied, dependent upon the particular desires of the user. As shown, suspension lines 23 secure the edge of skirt 27 to the lower end of tube 18.

It should be understood that any suitable type of opening system, such as those known in the art of umbrellas, may be used to automatically open the canopy 28, which is mounted on the upper end of telescoping tube 18 and actuated by the user pulling handle 14 (when the user is securely held by harness 12), which pulls cord 20 and, in turn, releases spring-biased catch 16 to expand tube 18 and cause expansion of ribs 24.

Even with the improvements of parachute 10 over conventional parachutes or umbrellas, parachute 10 may not provide transport and deployment in a manner that is efficient and quick enough to deal with a particular emergency situation. Thus, a mechanically opening emergency parachute solving the aforementioned problems is desired.

### SUMMARY OF THE INVENTION

The mechanically opening emergency parachute is a parachute that may be opened quickly at low altitudes, such as during an emergency exit from an office building. The mechanically opening emergency parachute includes a tube having opposed upper and lower ends, with an upper end of a suspension cord being secured to the lower end thereof.

A harness, adapted for releasably holding a user, is secured to the lower end of the suspension cord, and an upper annular runner is elastically and slidably mounted on the tube. A plurality of ribs are provided, with each rib having opposed first and second ends. The first end of each rib is pivotally secured to the upper end of the tube. The second end of each rib is free, with the plurality of ribs extending radially from the upper end of the tube.

An upper stretcher is mounted on the upper annular runner and includes a plurality of supports, with each support extending from the upper annular runner to a respective one of the plurality of ribs. A lower stretcher is secured to the lower end of the suspension cord and includes a plurality of risers, with each riser radially extending from the lower stretcher.

A canopy is secured to the plurality of ribs, and a plurality of suspension lines respectively extend between the plurality of risers and a peripheral edge of the canopy.

These and other features of the present invention will become readily apparent upon further review of the following specification and drawings.

### BRIEF DESCRIPTION OF THE DRAWINGS

FIG. 1 is a side view of a mechanically opening emergency parachute according to the present invention, partially broken away to show details thereof.

FIG. 2 is a diagrammatic side view of a conventional prior art umbrella.

FIG. 3 is a schematic view of a portion of a conventional prior art automatic umbrella.

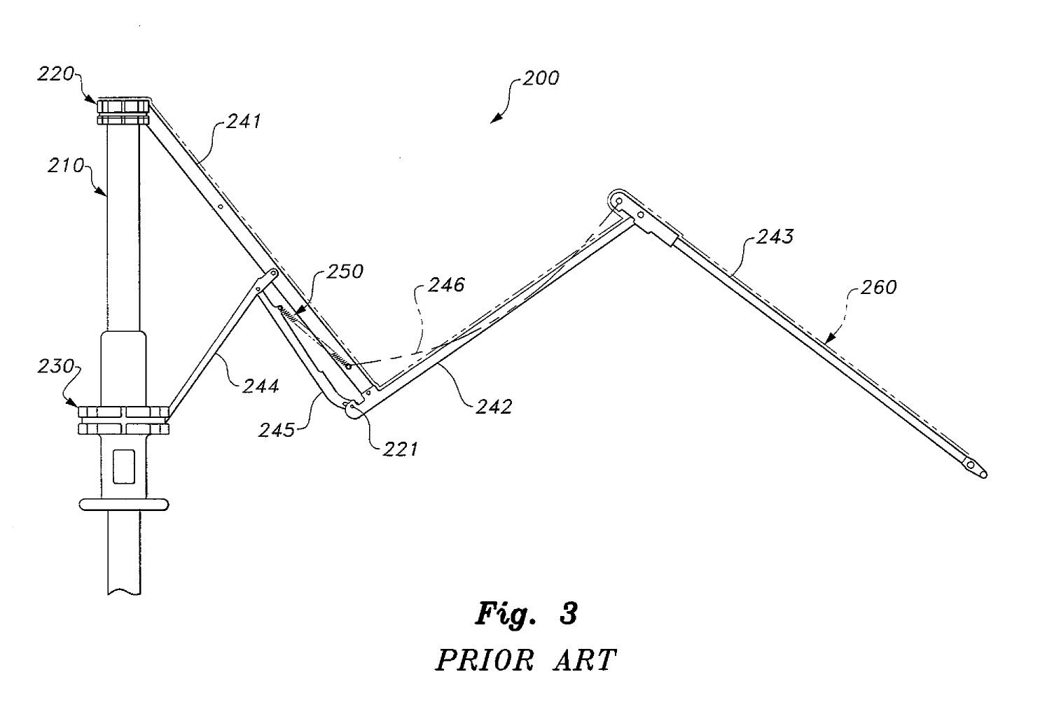

FIG. 4 is a perspective view showing a resilient wire and a collapsing tension spring of the conventional prior art automatic umbrella of FIG. 3.

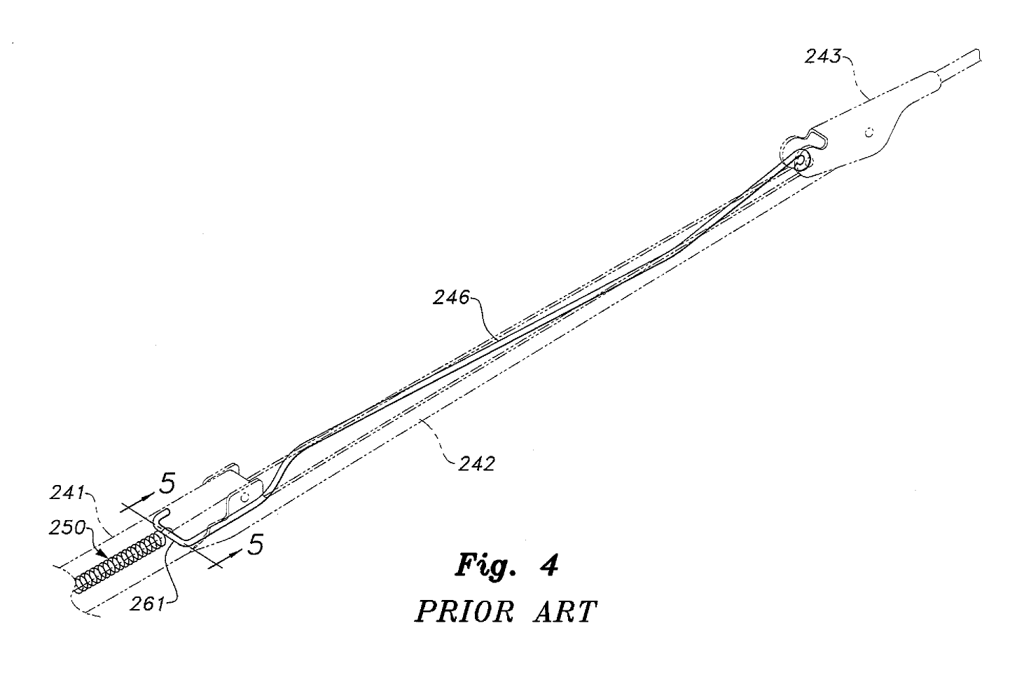

FIG. 5 is a section view taken along lines 5-5 of FIG. 4.

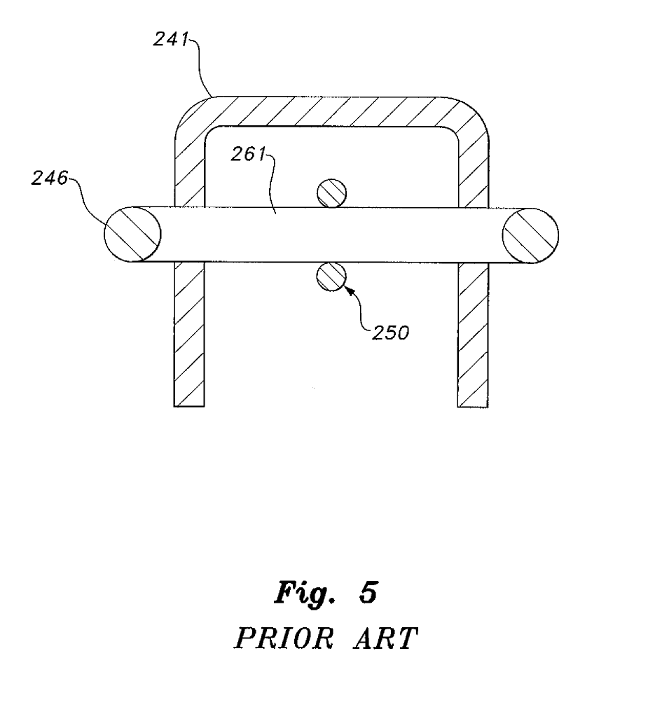

FIG. 6 is a perspective view of the conventional prior art automatic umbrella of FIG. 3 in a stretched state.

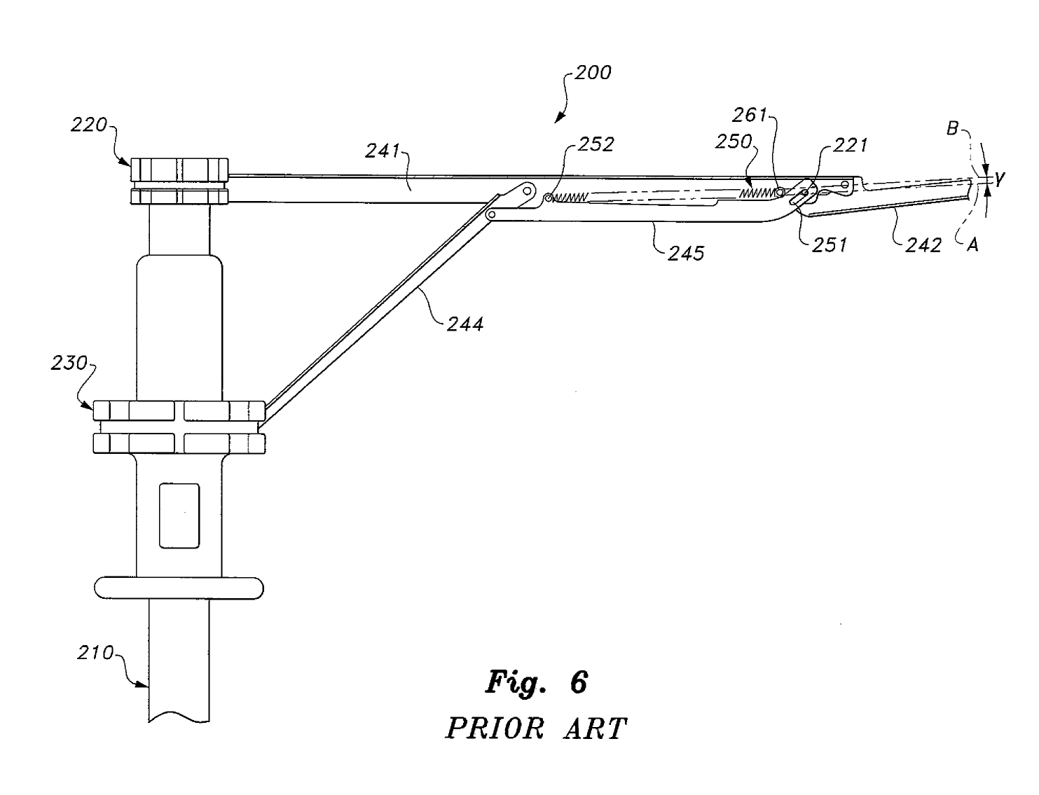

FIG. 7 is an environmental side view of a prior art mechanically opening parachute, partially broken away to show details thereof.

FIG. 8 is a side view of a portion of the mechanically opening emergency parachute of FIG. 1.

FIG. 9 is a side view of a pair of mechanically opening emergency parachutes linked together according to the present invention, the view being broken away to show details thereof.

Similar reference characters denote corresponding features consistently throughout the attached drawings.

### DETAILED DESCRIPTION OF THE PREFERRED EMBODIMENTS

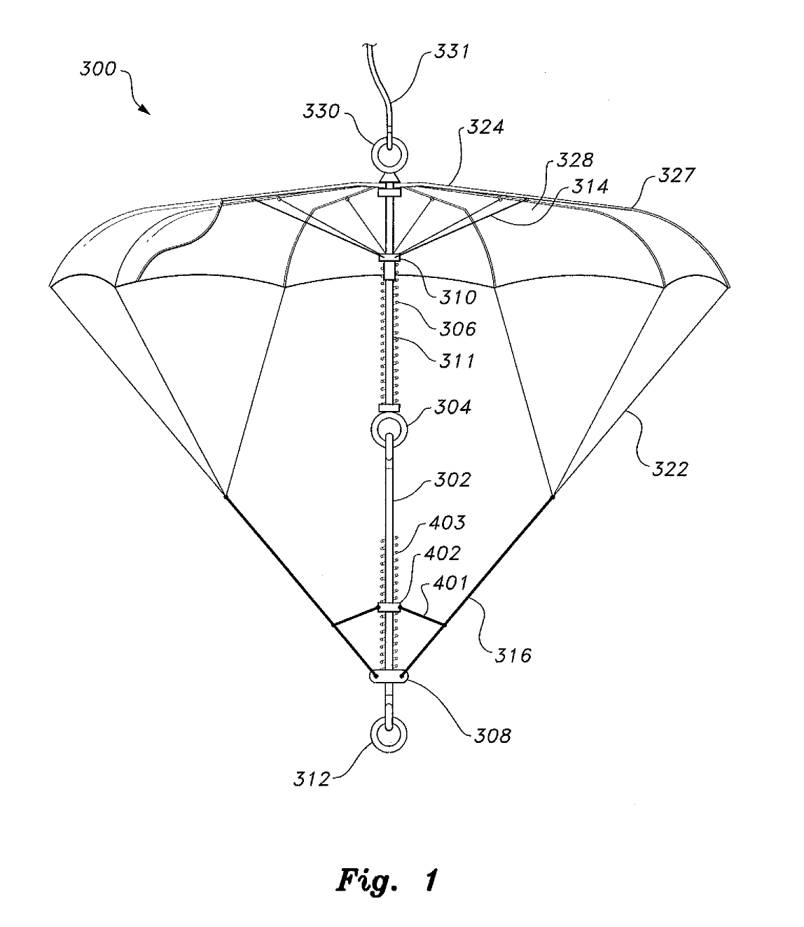

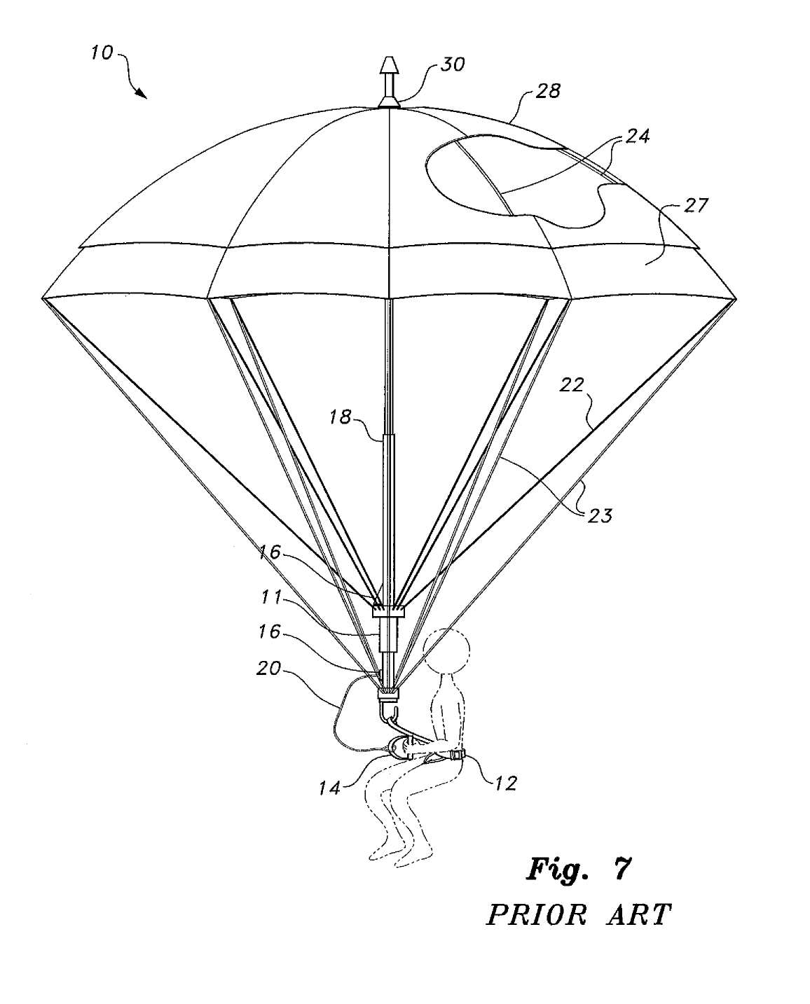

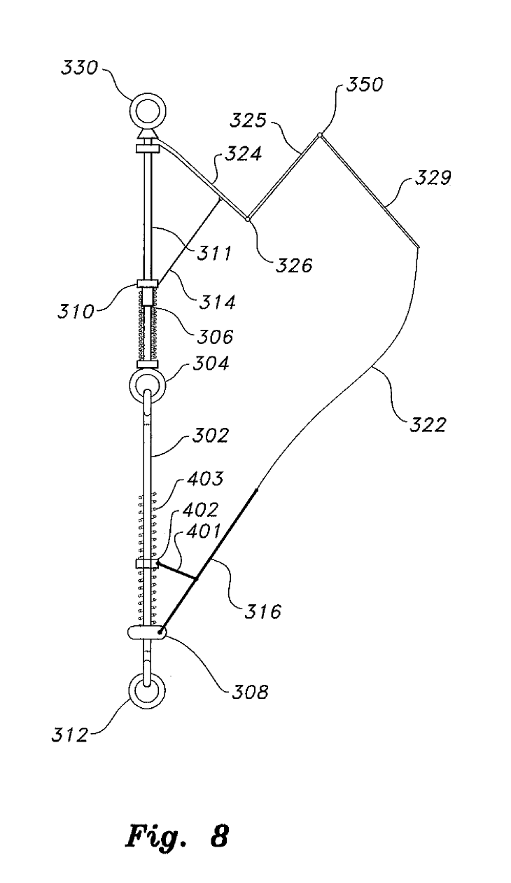

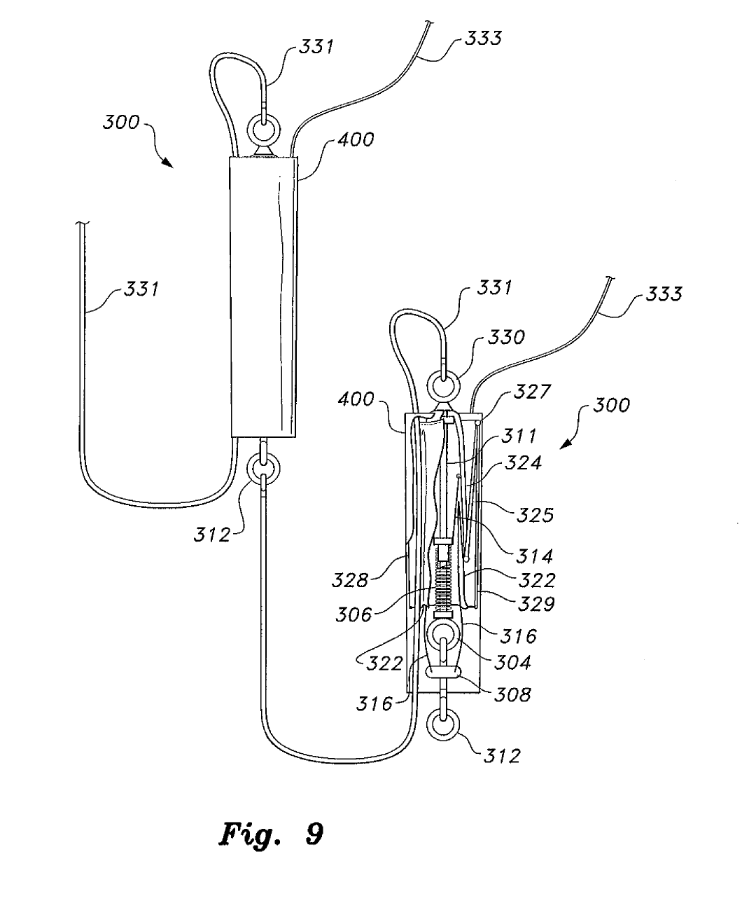

The mechanically opening emergency parachute 300, shown in FIGS. 1 and 8, is similar to the prior art mechanically opening parachute 10 of FIG. 7, however telescopic tube 18 is replaced by a tube 311, having opposed upper and lower ends, with a suspension cord 302 being tied or otherwise secured to lower end 304 thereof. It should be understood that suspension cord 302 may, alternatively, be removed. However, in the preferred embodiment, suspension cord 302 is secured to lower end 304. A ring or other mount 312 is provided on the lower end of the suspension cord 302, as shown, allowing for attachment of a harness, such as harness 12 of FIG. 7. The upper end 330 of tube 311 has a similar mount formed thereon, allowing for a cord or line 331 to be secured thereto. The cord or line 331 attached to upper end 330 may be fixed, at its other end, to the lower mount 312 of a second parachute 300, thus allowing multiple users to escape from an emergency situation together (as shown in FIG. 9).

The harness 12 and line 331 may be secured to the respective lower and upper ends by any suitable type of attachment. Replacing the annular runner 11 and stretcher 22 of the prior art parachute 10 of FIG. 7, a lower stretcher 308 is secured to the lower end of the suspension cord 302, as shown, with a plurality of risers 316 extending radially outwardly therefrom, similar in configuration to that of conventional parachute lines. Risers 316 are pivotally secured to lower stretcher 308, as is conventionally known.

A sliding runner 310, similar to a conventional umbrella runner, is mounted adjacent the upper end of tube 311, as shown. Sliding runner 310 is preferably elastically biased, with a helical spring or the like being wrapped about tube 311, and extending between sliding runner 310 and the lower end 304. A plurality of push rods 314 extend radially outwardly from the sliding runner 310, similar in configuration to that of a conventional umbrella stretcher.

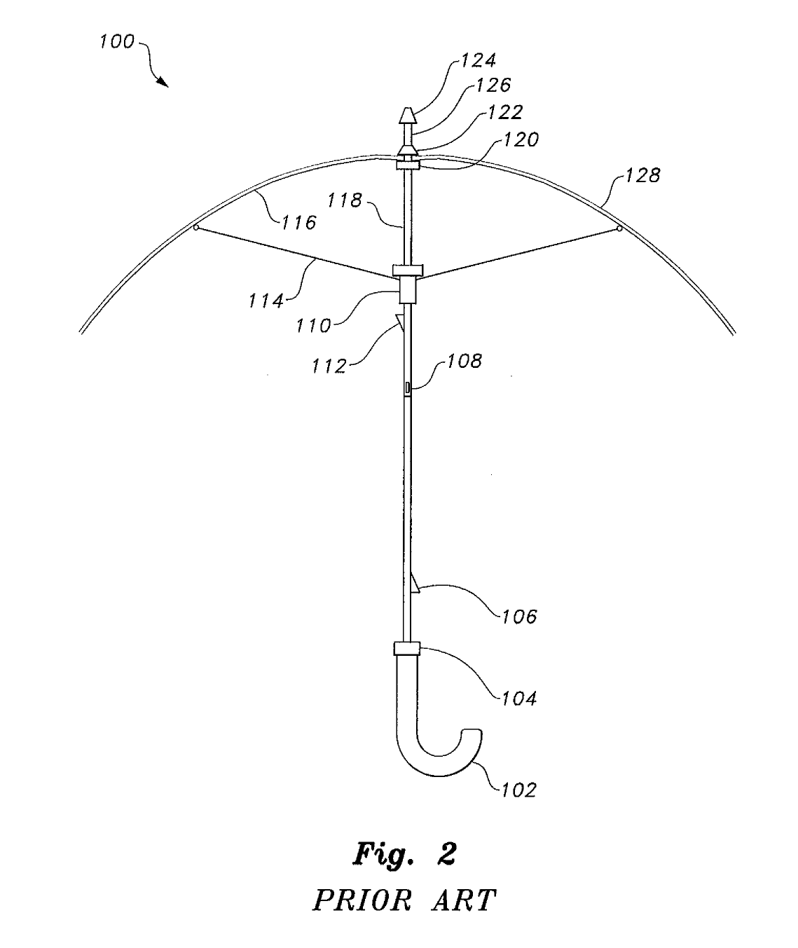

The plurality of radially extending push rods 314, as is well-known, are pivotally mounted on the sliding runner 310 for extending ribs 324 (and the attached canopy 328) as runner 310 slides upwardly with respect to tube 311. Ribs 324 and canopy 328 extend from an upper end of tube 311, which may be a notched end 330, such as that shown in the conventional umbrella of FIG. 2. Preferably, as best shown in FIG. 8, inner, middle and outer sets of ribs 324, 325, 329, respectively, are provided, with push rods 314 being pivotally joined to the inner set of ribs 324. Middle ribs 325 are respectively pivotally secured to the inner ribs 324 at respective pivot points 326 and, similarly, the outer set of ribs 329 are respectively pivotally joined to the middle set of ribs 325 at pivots points 350. Preferably, an annular skirt 327 is formed about the lower edge of canopy 328, as shown, in order to maximize stability during usage, with the annular skirt 327 being secured to the outer set of ribs 329. It should be understood that the overall contouring of canopy 328 or skirt 327 may be varied, dependent upon the particular desires of the user. Ribs 324 are shown as being conventional, multi-part folding ribs, however it should be understood that the overall configuration of ribs 324 may be varied, dependent upon the needs of the user. For example, non-folding ribs may alternatively be utilized.

As a further alternative, as shown in FIG. 1, a lower runner 402 may be added, with lower runner 402 being elastically mounted (via helical spring 403 or the like, similar to helical spring 306) on cord 302, with arms 401 joining the lower runner 402 to lines 316 (in a manner similar to the push rods 314, or a conventional umbrella spreader). This alternative would allow for an overall decrease in height of the parachute 300.

As shown, each riser 316 has a suspension line 322 extending therefrom, with an opposite end of each suspension line 322 being fixed to a lower edge of the annular skirt 327. By replacing the risers 22 of the prior art parachute 10 with a combination of rigid risers 316 and the flexible suspension lines 322 (which may be ropes or any other suitable type of lines) and, similarly, replacing the telescoping tube 18 with the tube 311 and the flexible suspension cord 302, the emergency parachute 300 is able to be collapsed and deployed in a much quicker and more efficient manner. It should be understood that the angling of riser 316 in FIG. 1 is shown for exemplary and illustrative purposes only. Preferably, riser 316 has a maximum angled, full extension such that risers 316 are substantially horizontal when fully deployed, thus reducing the overall height of the parachute.

Emergency parachute 300 is shown in a collapsed state in FIG. 9. Lower end 304 may be secured by a quick release pin or the like to lower mount 312 or annular mount 308, allowing for rapid deployment of the parachute through decompression of spring 306. A first parachute is shown as being secured to a second parachute in FIG. 9, via line 331. The second parachute is shown folded within a cover 400. Cover 400 may be used in conjunction with the quick release when in the stored, collapsed state, or may be used as the sole means for maintaining the parachute in the collapsed state. Upon removal of cover 400, the spring 306 will decompress, thus deploying the parachute 300.

As an alternative, multiple such parachutes may be secured together, allowing multiple users to exit the building together. For example, a cable may be secured from the upper end of one telescoping tube 18 of one parachute 10 and extend to the lower end of the next telescoping tube 18, or to the harness of the next parachute 10. Parachutes 10 would be daisy-chained together in such a scenario.

In FIG. 9, line 331, joining mount 312 of one parachute 300 with the upper end 330 of a second parachute, is shown passing through the interior of the cover 400 of the second parachute. In this daisy-chained scenario, tension from this line as line 331 is pulled (caused by deployment of the first parachute) will cause the cover 400 of the second parachute to release, thus deploying the second parachute. Additionally, lines 333 may connect the covers 400 to an interior wall or other support surface, thus allowing for instant removal of covers 400 (and deployment of the parachutes) as the user jumps from a window, for example. It should be understood that even when separate parachutes 300 are not secured together, removal of the cover 400 allows for automatic deployment of the parachute contained within.

It should be understood that any suitable type of opening mechanism may be utilized, such as an accordion-style opening mechanism, as is well-known in the art, and what is shown in FIG. 1 is shown for exemplary purposes only. Further, relative dimensions and overall contouring are ultimately dependent upon desired size and weight considerations, and the particular folding of the canopy is further dependent upon such size and weight considerations. Additionally, the opening mechanism, including the runners, tube and other conventional elements, may be any suitable opening mechanism, allowing for opening of the canopy in a manner similar to that of a conventional umbrella. Following usage of the parachute 300, the canopy 328 may be used for other purposes, such as the formation of an emergency tent or shelter, using any suitable type of support rods or the like.

It is to be understood that the present invention is not limited to the embodiments described above, but encompasses any and all embodiments within the scope of the following claims.

I claim:

1. A mechanically opening emergency parachute, comprising:
a tube having opposed upper and lower ends;
a suspension cord having opposed upper and lower ends, the upper end of the suspension cord being attached to the lower end of the tube;
a harness adapted for releasably holding a user, the harness being attached to the lower end of the suspension cord;
an upper annular runner slidably mounted on the tube;
a plurality of ribs, each of the ribs having opposed first and second ends, the first end of each of the ribs being pivotally attached to the upper end of the tube, the second end of each of the ribs being free, the plurality of ribs extending radially from the upper end of the tube;
an upper stretcher mounted on the upper annular runner, the upper stretcher having a plurality of supports, each of the supports extending from the upper annular runner to a respective one of the plurality of ribs;
a lower stretcher attached to the lower end of the suspension cord, the lower stretcher having a plurality of risers radially extending therefrom;
a canopy attached to the plurality of ribs, the canopy having a peripheral edge; and
a plurality of suspension lines respectively extending between the plurality of risers and the peripheral edge of the canopy.

2. The mechanically opening emergency parachute as recited in claim 1, further comprising means for automatically expanding the plurality of ribs from a collapsed state.

3. The mechanically opening emergency parachute as recited in claim 2, wherein said upper annular riser is resiliently biased with respect to the lower end of said tube.

4. The mechanically opening emergency parachute as recited in claim 3, wherein each said rib comprises a plurality of support members, adjacent ones of said plurality of support members being pivotally joined together.

5. The mechanically opening emergency parachute as recited in claim 4, further comprising an annular skirt secured to the peripheral edge of said canopy.

6. The mechanically opening emergency parachute as recited in claim 1, further comprising a lower runner slidably mounted on the suspension cord.

7. The mechanically opening emergency parachute as recited in claim 6, further comprising a plurality of pivotal arms respectively extending between the lower runner and the plurality of risers of said lower stretcher.

8. The mechanically opening emergency parachute as recited in claim 7, wherein the lower runner is resiliently biased with respect to the lower end of said suspension cord.

9. The mechanically opening emergency parachute as recited in claim 8, further comprising a cover releasably covering the mechanically opening emergency parachute when the mechanically opening emergency parachute is in a collapsed state.

10. The mechanically opening emergency parachute as recited in claim 9, further comprising an upper ring mounted on the upper end of said tube and a lower ring mounted on the lower end of said suspension cord.

11. The mechanically opening emergency parachute as recited in claim 10, further comprising a line having opposed first and second ends, the first end of the line being secured to the upper ring, the second end of the line being adapted for attachment to the lower ring of an adjacent mechanically opening emergency parachute.

12. A mechanically opening emergency parachute, comprising:
a tube having opposed upper and lower ends;
a suspension cord having opposed upper and lower ends, the upper end of the suspension cord being attached to the lower end of the tube;
a harness adapted for releasably holding a user, the harness being attached to the lower end of the suspension cord;
an upper annular runner slidably mounted on the tube;
a plurality of ribs, each of the ribs having opposed first and second ends, the first end of each of the ribs being pivotally attached to the upper end of the tube, the second end of each of the ribs being free, the plurality of ribs extending radially from the upper end of the tube;
an upper stretcher mounted on the upper annular runner, the upper stretcher having a plurality of supports, each of the supports extending from the upper annular runner to a respective one of the plurality of ribs;
a lower stretcher attached to the lower end of the suspension cord, the lower stretcher having a plurality of risers radially extending therefrom;
a lower runner slidably mounted on the suspension cord;
a canopy attached to the plurality of ribs, the canopy having a peripheral edge; and
a plurality of suspension lines respectively extending between the plurality of risers and the peripheral edge of the canopy.

13. The mechanically opening emergency parachute as recited in claim 12, further comprising means for automatically expanding the plurality of ribs from a collapsed state.

14. The mechanically opening emergency parachute as recited in claim 13, wherein said upper annular riser is resiliently biased with respect to the lower end of said tube.

15. The mechanically opening emergency parachute as recited in claim 14, wherein each said rib comprises a plurality of support members, adjacent ones of said plurality of support members being pivotally joined together.

16. The mechanically opening emergency parachute as recited in claim 15, further comprising an annular skirt secured to the peripheral edge of said canopy.

17. The mechanically opening emergency parachute as recited in claim 16, further comprising a plurality of pivotal arms respectively extending between the lower runner and the plurality of risers of said lower stretcher.

18. The mechanically opening emergency parachute as recited in claim 17, wherein the lower runner is resiliently biased with respect to the lower end of said suspension cord.

19. The mechanically opening emergency parachute as recited in claim 18, further comprising a cover releasably covering the mechanically opening emergency parachute when the mechanically opening emergency parachute is in a collapsed state.

20. The mechanically opening emergency parachute as recited in claim 19, further comprising:
an upper ring mounted on the upper end of said tube;
a lower ring mounted on the lower end of said suspension cord; and
a line having opposed first and second ends, the first end of the line being attached to the upper ring, the second end of the line being adapted for attachment to the lower ring of an adjacent mechanically opening emergency parachute.
